(19) United States
(12) Patent Application Publication
(10) Pub. No.: US 2021/0061276 A1
(43) Pub. Date: Mar. 4, 2021

(54) SYSTEMS AND METHODS FOR VEHICLE OPERATOR INTENTION PREDICTION USING EYE-MOVEMENT DATA

(71) Applicant: GM Global Technology Operations LLC, Detroit, MI (US)

(72) Inventor: Yunxiu Zhang, Shanghai (CN)

(73) Assignee: GM GLOBAL TECHNOLOGY OPERATIONS LLC, Detroit, MI (US)

(21) Appl. No.: 16/552,449

(22) Filed: Aug. 27, 2019

(51) Int. Cl. B60W 30/18; B60W 10/18; B60W 10/20; B60W 10/04; B60W 50/08; B60W 40/08

(52) U.S. Cl. CPC B60W 30/18; B60W 10/18; B60W 10/20; B60W 10/04; B60W 50/08; B60W 2050/0028; B60W 2720/106; B60W 2710/18; B60W 2710/20; B60W 2520/105; B60W 2540/18; B60W 40/08

(57) ABSTRACT

A method for controlling an automotive vehicle includes providing a first actuator configured to control acceleration and braking of the first vehicle, a second actuator configured to control steering of the first vehicle, and a controller in communication with the first and second actuators, the controller configured to selectively control the first and second actuators in an autonomous mode along a first trajectory according to an automated driving system, receiving eye movement data and vehicle characteristic data from a second vehicle using V2X communication, determining a predicted vehicle maneuver of the second vehicle from the eye movement data and the vehicle characteristic data, determining a trajectory adjustment for the first vehicle to the predicted vehicle maneuver of the second vehicle, and automatically controlling the first and second actuators to implement the trajectory adjustment.

### INTRODUCTION

The present disclosure relates generally to systems and methods for predicting the maneuvers of surrounding vehicles using eye-movement data and to vehicles controlled by automated driving systems, particularly those configured to automatically control vehicle steering, acceleration, and braking during a drive cycle without human intervention.

The operation of modern vehicles is becoming more automated, i.e. able to provide driving control with less and less driver intervention. Vehicle automation has been categorized into numerical levels ranging from Zero, corresponding to no automation with full human control, to Five, corresponding to full automation with no human control. Various automated driver-assistance systems, such as cruise control, adaptive cruise control, and parking assistance systems correspond to lower automation levels, while true “driverless” vehicles correspond to higher automation levels.

Typically, autonomous or semi-autonomous vehicles do not have a way to predict the maneuvers of surrounding vehicles. Vehicle-to-everything (V2X) communication is the passing of information from a vehicle to any entity that may affect the vehicle, and vice versa. V2X is a vehicular communication system that incorporates other, more specific types of communication such as vehicle-to-infrastructure (V2I), vehicle-to-network (V2N), vehicle-to-vehicle (V2V), vehicle-to-pedestrian (V2P), and vehicle-to-grid (V2G). Eye tracking is the process of measuring either the point of gaze (where one is looking) or the motion of an eye relative to the head. Methods and systems to collect eye gaze information, map the information to the surrounding environment, and share the information with surrounding vehicles can be used to inform the intent of an autonomous, semi-autonomous, or driver-operated vehicle.

### SUMMARY

Embodiments according to the present disclosure provide a number of advantages. For example, embodiments according to the present disclosure enable prediction, by an autonomous or semi-autonomous vehicle, of an intended vehicle maneuver based on eye-movement data received from a nearby vehicle and trajectory adjustment to the current trajectory of the autonomous or semi-autonomous vehicle based on the predicted maneuver of the nearby vehicle.

In one aspect of the present disclosure, a method for controlling an automotive vehicle includes providing a first actuator configured to control acceleration and braking of a first vehicle, a second actuator configured to control steering of the first vehicle, and a controller in communication with the first and second actuators. The controller is configured to selectively control the first and second actuators in an autonomous mode along a first trajectory according to an automated driving system. The method also includes receiving, by the controller, eye movement data and vehicle characteristic data from a second vehicle using V2X communication, determining, by the controller, a predicted vehicle maneuver of the second vehicle from the eye movement data and the vehicle characteristic data, determining, by the controller, a trajectory adjustment for the first vehicle based on the predicted vehicle maneuver of the second vehicle, and automatically controlling, by the controller, the first and second actuators to implement the trajectory adjustment.

In some aspects, the method further includes analyzing, by the controller, the eye movement data and the vehicle characteristic data to temporally correlate the eye movement data and the vehicle characteristic data and generate a matched dataset.

In some aspects, the eye movement data includes a gaze position and a gaze duration.

In some aspects, the vehicle characteristic data includes a vehicle speed, a vehicle acceleration, and a vehicle steering wheel angle of the second vehicle.

In some aspects, the matched dataset includes the gaze position, a duration of the gaze position, the vehicle speed, the vehicle acceleration, the vehicle steering wheel angle, and a vehicle position.

In some aspects, the method further includes determining, by the controller, a prediction model status, wherein the prediction model status is whether a prediction model is locally stored on the controller of the first vehicle.

In some aspects, the method further includes accessing, by the controller via V2X communication, a remote source hosting an updated prediction model if the prediction model is not locally stored on the controller of the first vehicle.

In some aspects, the method further includes transmitting, by the controller via V2X communication, the eye movement data and the vehicle characteristic data to the remote source.

In some aspects, the trajectory adjustment includes one or more of a longitudinal, lateral, and speed adjustment to the first trajectory of the first vehicle.

In another aspect of the present disclosure, an automotive vehicle includes a wireless communication system configured to transmit and receive V2X communication, a first actuator configured to control acceleration and braking of the automotive vehicle, a second actuator configured to control steering of the automotive vehicle, and a controller in communication with the first and second actuators and the wireless communication system. The controller is configured to selectively control the first and second actuators in an autonomous mode along a first trajectory according to an automated driving system. The controller is also configured to receive eye movement data and vehicle characteristic data from a second vehicle via the wireless communication system using V2X communication, determine a predicted vehicle maneuver of the second vehicle from the eye movement data and the vehicle characteristic data, determine a trajectory adjustment for the automotive vehicle based on the predicted vehicle maneuver of the second vehicle, and automatically control the first and second actuators to implement the trajectory adjustment.

In some aspects, the controller is further configured to analyze the eye movement data and the vehicle characteristic data to temporally correlate the eye movement data and the vehicle characteristic data and generate a matched dataset.

In some aspects, the controller is further configured to determine a prediction model status, wherein the prediction model status is whether a prediction model is locally stored on the controller of the automotive vehicle.

In some aspects, the controller is further configured to access, via V2X communication, a remote source hosting an updated prediction model if the prediction model is not locally stored on the controller of the automotive vehicle.

In some aspects, the controller is further configured to transmit, via V2X communication, the eye movement data and the vehicle characteristic data to the remote source.

In some aspects, the trajectory adjustment includes one or more of a longitudinal, lateral, and speed adjustment to the first trajectory of the automotive vehicle.

In yet another aspect of the present disclosure, a system for controlling an automotive vehicle includes a wireless communication system, a first actuator configured to control acceleration and braking of the automotive vehicle, a second actuator configured to control steering of the automotive vehicle, and a controller in communication with the first and second actuators. The controller is configured to selectively control the first and second actuators in an autonomous mode along a first trajectory according to an automated driving system. The controller is further configured to receive eye movement data and vehicle characteristic data from a second vehicle using V2X communication, analyze the eye movement data and the vehicle characteristic data to temporally correlate the eye movement data and the vehicle characteristic data and generate a matched dataset, determine a predicted vehicle maneuver of the second vehicle from the matched dataset, determine a trajectory adjustment for the automotive vehicle based on the predicted vehicle maneuver of the second vehicle, and automatically control the first and second actuators to implement the trajectory adjustment.

In some aspects, the controller is further configured to determine a prediction model status, wherein the prediction model status is whether a prediction model is locally stored on the controller of the automotive vehicle.

In some aspects, the controller is further configured to access, via V2X communication using the wireless communication system, a remote source hosting an updated prediction model if the prediction model is not locally stored on the controller of the automotive vehicle.

In some aspects, the controller is further configured to transmit, via V2X communication using the wireless communication system, the eye movement data and the vehicle characteristic data to the remote source.

In some aspects, the trajectory adjustment includes one or more of a longitudinal, lateral, and speed adjustment to the first trajectory of the automotive vehicle.

### BRIEF DESCRIPTION OF THE DRAWINGS

The present disclosure will be described in conjunction with the following figures, wherein like numerals denote like elements.

FIG. 1 is a schematic diagram of a vehicle, according to an embodiment of the present disclosure.

FIG. 2 is a schematic diagram of an eye-movement tracking system, according to an embodiment of the present disclosure.

FIG. 3 is a schematic diagram of five possible vehicle maneuvers that may be predicted using an eye-movement tracking system, according to an embodiment of the present disclosure.

FIG. 4 is a schematic diagram of eye-movement data mapping and correlation to vehicle data, according to an embodiment of the present disclosure.

FIG. 5 is a flow diagram of a method for predicting operating intention using eye-movement data, according to an embodiment of the present disclosure.

The foregoing and other features of the present disclosure will become more fully apparent from the following description and appended claims, taken in conjunction with the accompanying drawings. Understanding that these drawings depict only several embodiments in accordance with the disclosure and are not to be considered limiting of its scope, the disclosure will be described with additional specificity and detail through the use of the accompanying drawings. Any dimensions disclosed in the drawings or elsewhere herein are for the purpose of illustration only.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present disclosure. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Certain terminology may be used in the following description for the purpose of reference only, and thus are not intended to be limiting. For example, terms such as “above” and “below” refer to directions in the drawings to which reference is made. Terms such as “front,” “back,” “left,” “right,” “rear,” and “side” describe the orientation and/or location of portions of the components or elements within a consistent but arbitrary frame of reference which is made clear by reference to the text and the associated drawings describing the components or elements under discussion. Moreover, terms such as “first,” “second,” “third,” and so on may be used to describe separate components. Such terminology may include the words specifically mentioned above, derivatives thereof, and words of similar import.

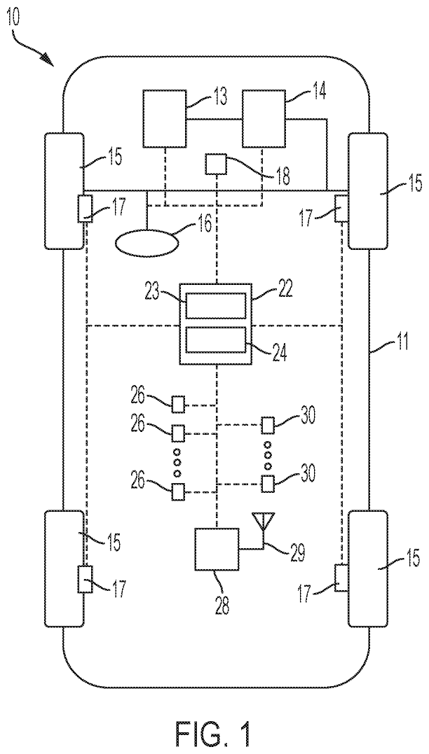

FIG. 1 schematically illustrates an automotive vehicle 10 according to the present disclosure. The vehicle 10 is depicted in the illustrated embodiment as a passenger car, but it should be appreciated that any other vehicle, including motorcycles, trucks, sport utility vehicles (SUVs), or recreational vehicles (RVs), etc., can also be used. The vehicle 10 can be a receiving vehicle, that is, a vehicle that receives eye-movement data from a nearby vehicle, or an originating vehicle, that is, an operator-controlled vehicle that collects and maps eye-movement data to operating data of the originating vehicle. The vehicle 10 includes a propulsion system 13, which may in various embodiments include an internal combustion engine, an electric machine such as a traction motor, and/or a fuel cell propulsion system.

The vehicle 10 generally includes a body 11 and wheels 15. The body 11 encloses the other components of the vehicle 10 and also defines a passenger compartment. The wheels 15 are each rotationally coupled to the body 11 near a respective corner of the body 11.

The vehicle 10 also includes a transmission 14 configured to transmit power from the propulsion system 13 to the plurality of vehicle wheels 15 according to selectable speed ratios. According to various embodiments, the transmission 14 may include a step-ratio automatic transmission, a continuously variable transmission, or other appropriate transmission.

The vehicle 10 additionally includes a steering system 16. While depicted as including a steering wheel for illustrative purposes, in some embodiments contemplated within the scope of the present disclosure, the steering system 16 may not include a steering wheel.

The vehicle 10 additionally includes a braking system including wheel brakes 17 configured to provide braking torque to the vehicle wheels 15. The wheel brakes 17 may, in various embodiments, include friction brakes, a regenerative braking system such as an electric machine, and/or other appropriate braking systems.

In various embodiments, the vehicle 10 also includes a wireless communication system 28 configured to wirelessly communicate with any wireless communication equipped device (vehicle-to-everything or “V2X”), including other vehicles (“V2V”) and/or infrastructure (“V2I”). In an exemplary embodiment, the wireless communication system 28 is configured to communicate via a dedicated short-range communications (DSRC) channel. DSRC channels refer to one-way or two-way short-range to medium-range wireless communication channels specifically designed for automotive use and a corresponding set of protocols and standards. However, wireless communications systems configured to communicate via additional or alternate wireless communications standards, such as IEEE 802.11 and cellular data communication, are also considered within the scope of the present disclosure. Additionally, wireless communication systems configured to communicate with traffic lights, cellular towers or relays, etc. using LTE, 5G, and other communication standards, are also considered within the scope of the present disclosure. In various embodiments, the wireless communication system 28 includes one or more antennas 29 configured to receive and transmit wireless communication signals. In various embodiments, the one or more antennas are directional antennas.

The propulsion system 13, transmission 14, steering system 16, and wireless communication system 28 are in communication with or under the control of at least one controller 22. While depicted as a single unit for illustrative purposes, the controller 22 may additionally include one or more other controllers, collectively referred to as a “controller.” The controller 22 may include a microprocessor or central processing unit (CPU) in communication with various types of computer readable storage devices or media. Computer readable storage devices or media may include volatile and nonvolatile storage in read-only memory (ROM), random-access memory (RAM), and keep-alive memory (KAM), for example. KAM is a persistent or non-volatile memory that may be used to store various operating variables while the CPU is powered down. Computer-readable storage devices or media may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller 22 in controlling the vehicle.

In various embodiments, the vehicle 10 includes an eye-movement tracking system 18. The eye-movement tracking system 18 includes one or more eye-tracking devices known to those skilled in the art to capture eye-movement data corresponding to the driver's eye movements within the vehicle. The eye-movement tracking system 18 is in communication with the controller 22. In various embodiments, the controller 22 includes an eye-movement data analysis system 24 for receiving and analyzing signals and messages received via the eye-movement tracking system 18. The controller 22 receives the eye-movement data and analyzes this data to map the driver's eye movement with vehicle data including vehicle speed, acceleration, steering wheel angle, GPS position, etc., for example and without limitation.

In various embodiments, the controller 22 includes an automated driving system (ADS) 23 for automatically controlling various actuators in the vehicle. In an exemplary embodiment, the ADS 23 is a so-called Level Four or Level Five automation system. A Level Four system indicates “high automation”, referring to the driving mode-specific performance by an automated driving system of all aspects of the dynamic driving task, even if a human driver does not respond appropriately to a request to intervene. A Level Five system indicates “full automation”, referring to the full-time performance by an automated driving system of all aspects of the dynamic driving task under all roadway and environmental conditions that can be managed by a human driver. In an exemplary embodiment, the ADS 23 is configured to control the propulsion system 13, transmission 14, steering system 16, and wheel brakes 17 to control vehicle acceleration, steering, and braking, respectively, without human intervention via a plurality of actuators 30 in response to inputs from a plurality of sensors 26, which may include GPS, RADAR, LIDAR, optical cameras, thermal cameras, ultrasonic sensors, and/or additional sensors as appropriate to capture vehicle characteristic or operating conditions including, for example and without limitation, vehicle speed, acceleration, and steering wheel angle.

Typically, vehicles, whether autonomous or semi-autonomous, do not have a way to predict the maneuvers of surrounding autonomous, semi-autonomous, or driver-operated vehicles. The systems and methods discussed herein enable the analysis of eye-movement data received from surrounding, driver-operated vehicles using V2X communications. The eye-movement data may be used to improve operator- or vehicle-intention predictions and/or to improve vehicle control strategies.

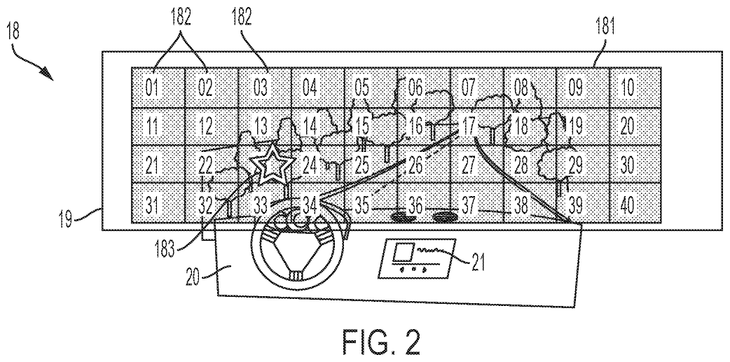

FIG. 2 is a schematic illustration of components of the eye-movement tracking system 18 of the vehicle 10, according to an embodiment. The eye-movement tracking system 18 includes, in some embodiments, a virtual grid 181 that covers the front windshield area, and, in some embodiments, the side view mirrors of the vehicle 10. The virtual grid 181 is divided into a plurality of grid areas 182. The grid areas 182 are uniquely identified with a marker, such as a number, letter, or any combination forming a unique identification of the location of the grid area 182.

As shown the virtual grid 181 may be mapped to cover the area of a front windshield 19 of the vehicle 10, above a vehicle dashboard 20 that may include the steering wheel of the steering system 16 and a vehicle information system 21. The front windshield 19 offers a view of the environment forward and surrounding the vehicle 10, as illustrated in FIG. 2.

In various embodiments, eye tracking devices mounted within the passenger compartment of the vehicle 10 including, for example and without limitation, one or more eye tracking cameras or other eye tracking sensors in communication with the eye-movement tracking system 18, detect a gaze position of the vehicle operator, indicated by the star 183. The gaze position 183 is mapped onto the virtual grid 181 and associated with a corresponding grid area 182. In various embodiments, the corresponding grid area 182 information is transmitted to the controller 22 to be analyzed by the eye-movement data analysis system 24. In various embodiments, a series of gaze positions (that is, eye gaze tracking data) are recorded and analyzed by the eye-movement data analysis system 24 to identify patterns of eye movement that indicate an intended vehicle operation.

In various embodiments, the eye-movement tracking system 18 also includes a timer. The timer may be incorporated into the controller 22, the eye-movement tracking system 18, or may be in communication with one or both of the controller 22 and the eye-movement tracking system 18. The timer measures a duration of the operator's gaze at the corresponding grid area 182. In various embodiments, the eye-movement tracking system 18 measures the gaze position and gaze duration of the vehicle operator's gaze at regular intervals, e.g., 100 ms, for example and without limitation.

Vehicle data acquired by one or more of the sensors 26 including, for example and without limitation, vehicle speed, acceleration, steering wheel angle, navigation data including positioned determined using GPS, etc. is acquired simultaneously. For example, vehicle data having the same time stamp as the gaze position and duration data is acquired by the sensors 26 and received by the controller 22 for use by the eye-movement data analysis system 24.

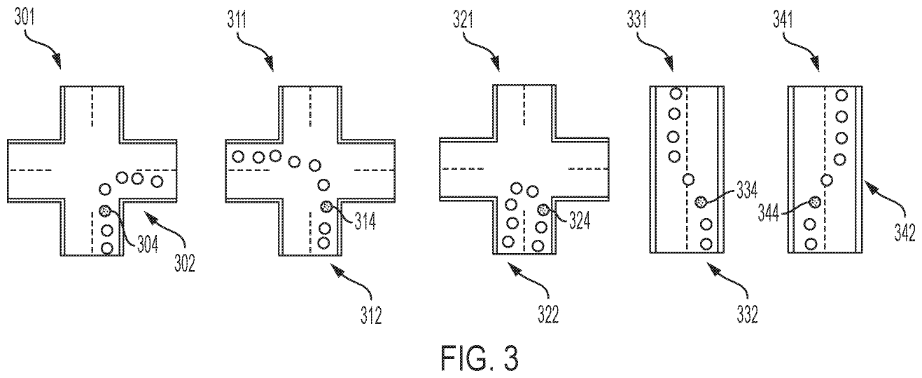

As shown in FIG. 3, several examples of vehicle maneuvers are illustrated at 301, 311, 321, 331, 341. Each of the vehicle maneuvers 301, 311, 321, 331, 341 has associated vehicle characteristic or operating data including, for example and without limitation, vehicle speed, acceleration, steering wheel angle, GPS position, etc. The controller 22 receives the vehicle data and analyzes the data to identify vehicle driving behavior. For example, the controller 22 receives vehicle operating data 302, 312, 322, 332, 342 associated with each of the maneuvers 301, 311, 321, 331, 341. The vehicle operating data 302, 312, 322, 332, 342 is vehicle operating data acquired in regular intervals, in some embodiments, acquired at the same intervals as the gaze position and duration data acquired by the eye-movement tracking system 18.

The controller 22 analyzes the data and determines a start point of each maneuver, such as the start point 304 of the maneuver 301. The start point 304 of the maneuver 301 is flagged by the controller 22 as the operator intention point, that is, the point at which the operator's intention is identified. For example, the start point 304 of maneuver 301 indicates that the operator intends to perform a right-hand turn. Similarly, the start point 314 of maneuver 311 indicates that operator intends to perform a left-hand turn. Continuing with maneuver 321, the start point 324 indicates that the operator intends to perform a U-turn. The start point 334 of maneuver 331 indicates that the operator intends to perform a lane change from the right lane to the left lane and the start point 344 of the maneuver 341 indicates that the operator intends to perform a lane change from the left lane to the right lane.

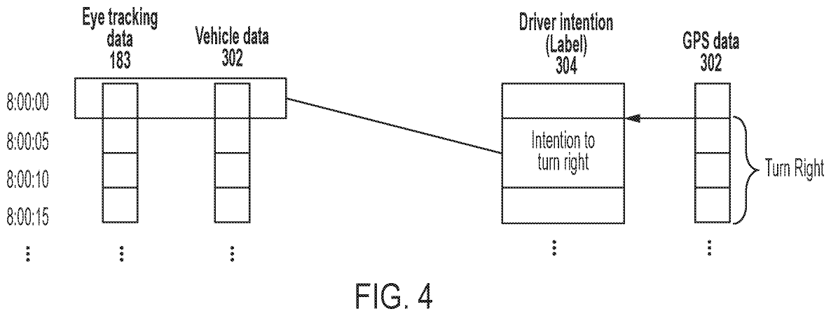

Once acquired by the eye-movement tracking system 18, the eye gaze position and duration data is correlated with the vehicle data, as shown in FIG. 4. At each time interval, the eye gaze position data 183 is correlated with vehicle data 302. The GPS or navigation data, included in the vehicle data 302, indicates the position of the vehicle at each measured time interval. In various embodiments, the operator intention point of the maneuver, such as the start point 304 of the right turn maneuver 301, is identified at a predetermined time interval prior to the start of the maneuver shown by the GPS vehicle data 302. In various embodiments, the predetermined time interval is approximately 5 (five) seconds.

The eye gaze tracking and position data, including, in some embodiments, the operator intention point and the data associated with the predicted maneuver, such as the vehicle data 302, is transmitted, in some embodiments, to nearby vehicles or other infrastructure using V2X via the wireless communication system 28. In various embodiments, the predicted maneuver information is transmitted using V2X to surrounding vehicles and infrastructure, such as a remote access center including one or more controllers. In other embodiments, the eye-movement tracking data, such as the data associated with the gaze position 183, and the associated vehicle data, such as the data 302, is transmitted to nearby vehicles or other infrastructure using V2X to be analyzed by the receiving vehicle or infrastructure to predict the operator's intended maneuver of the originating vehicle. The receiving vehicle is, in some embodiments, a vehicle similar to vehicle 10 that is an autonomous or semi-autonomous vehicle configured to receive the eye-movement and associated vehicle data regarding the operator's intended maneuver of the originating vehicle 10, analyze the data, predict the intended maneuver, and generate one or more control signals to control steering, braking, and throttle of the receiving vehicle to accommodate the predicted maneuver of the originating vehicle.

In various embodiments, the correlated gaze position and duration data and vehicle data is analyzed by the eye-movement data analysis system 24 of the controller 22 of the receiving vehicle 10. This analysis includes, in some embodiments, use of a prediction model. The prediction model analyzes a percentage of the eye gaze tracking and vehicle data as training datasets to predict an intended maneuver and performs validation of the prediction model using additional eye gaze tracking data and vehicle data as acquired to refine the prediction of the intended maneuver. In various embodiments, the prediction model is housed in the originating vehicle 10. In various embodiments, the prediction model is housed in the receiving vehicle 10, that is, a nearby vehicle to the originating vehicle that receives the gaze position and duration data and vehicle data from the originating vehicle 10. In various embodiments, the prediction model is housed in a controller external to the receiving vehicle 10 and data and/or control signals generated by the prediction model is transmitted to the receiving vehicle 10 via the wireless communication system 28.

The prediction model of the eye-movement data analysis system 24 receives the eye-movement gaze position and duration data, and associated vehicle operating data occurring at the same time as the recorded eye gaze position data, and using a variety of training datasets, learns to predict operator-intended vehicle maneuvers. The training datasets may include eye movement patterns that precede specific vehicle maneuvers, such as the maneuvers shown in FIG. 3.

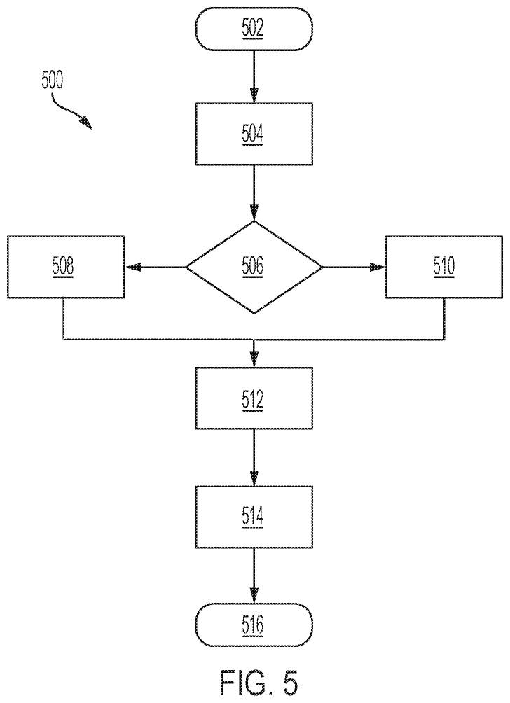

FIG. 5 illustrates a method 500 to predict an operator's intended vehicle maneuver using eye-movement data acquired from nearby vehicles, according to an embodiment. The method 500 can be utilized in connection with the receiving vehicle 10 and the controller 22, including the eye-movement data analysis system 24 and the eye-movement tracking system 18. The method 500 can be utilized in connection with the controller 22 as discussed herein, or by other systems associated with or separate from the vehicle, in accordance with exemplary embodiments. The order of operation of the method 500 is not limited to the sequential execution as illustrated in FIG. 5, but may be performed in one or more varying orders, or steps may be performed simultaneously, as applicable in accordance with the present disclosure.

Beginning at 502, the method 500 proceeds to 504. At 504, the controller 22 of the receiving vehicle 10 receives real-time eye gaze position data and correlated vehicle operating data from an operator-controlled vehicle, such as the originating vehicle 10, via V2X communication. The eye gaze position data includes eye gaze tracking data that has been correlated with vehicle operating data of the operator-controlled vehicle such that vehicle characteristics such as vehicle speed, acceleration, steering wheel position, and vehicle GPS position are temporally aligned with the operator's eye movements. In various embodiments, the data received by the receiving vehicle 10 has been correlated and aligned. In various embodiments, the controller 22 of the receiving vehicle 10 receives uncorrelated and unaligned eye gaze position data and vehicle operating data, analyzes the uncorrelated and unaligned data, and correlates and temporally aligns the data.

Next, at 506, the controller 22 of the receiving vehicle 10 determines whether a first condition is satisfied, that is, determining a prediction model status. In some embodiments, determining the prediction model status includes determining whether the eye-movement data analysis system 24 of the in-vehicle controller 22 includes a prediction model or if an updated prediction model is available from a remote source. In various embodiments, the remote source is a remote access center accessible via wireless or wired communications with the receiving vehicle 10. The remote access center includes, in various embodiments, one or more controllers. The updated prediction model may be accessed via V2X communication from a remote source via the wireless communication system 28. In various embodiments, the updated prediction model may be downloaded or acquired from the remote source via the wireless communication system 28 and then implemented on-board the receiving vehicle 10 by the eye-movement data analysis system 24 of the controller 22.

Upon satisfaction of the first condition, that is, the eye-movement data analysis system 24 of the in-vehicle controller 22 includes a prediction model, the method 500 proceeds to 508. At 508, the data received by the receiving vehicle 10, including the gaze position data and the correlated vehicle operating data is applied to the prediction model to predict the originating vehicle operator's intended maneuver, such as one of the maneuvers illustrated in FIG. 3.

If the first condition is not satisfied, that is, the eye-movement data analysis system 24 does not include a prediction model, or the prediction model is out of date, or an updated prediction model is available via a remote source and a communication link is established to the remote source, the method 500 proceeds to 510.

At 510, the controller 22, using V2X communication via the wireless communication system 28, transmits the eye gaze position data and correlated vehicle operating data to the remote source hosting the prediction model. The remote source, which is some embodiments is a controller, applies the eye gaze position data and correlated vehicle operating data to the prediction model to generate a prediction of the originating vehicle operator's intended maneuver, such as one of the maneuvers illustrated in FIG. 3. The intended maneuver prediction is transmitted to the receiving vehicle 10 via the wireless communication system 28.

From both 508 and 510, the method 500 proceeds to 512. At 512, the controller 22 uses the intended maneuver prediction generated either on-board the vehicle 10 or received from the remote source via the wireless communication system 28 to determine a response to the intended maneuver prediction. The response may include, in various embodiments, a planned longitudinal and/or lateral trajectory adjustment and/or speed adjustment to the current trajectory of the receiving vehicle such that the receiving vehicle 10 avoids or accommodates the predicted maneuver of the originating vehicle 10.

Next, at 514, the controller 22 of the receiving vehicle 10 uses the intended maneuver prediction generated either on-board the vehicle 10 or received from the remote source via the wireless communication system 28 and any planned trajectory or speed adjustment generated at 512 to generate one or more control signals to control the receiving vehicle 10. In various embodiments, the one or more control signals are transmitted from the controller 22 to one or more of the actuators 30 to control one or more of vehicle steering, braking, and throttling to automatically adjust the vehicle operating conditions of the receiving vehicle to accommodate the predicted vehicle maneuver being performed or intended to be performed, by the nearby originating vehicle 10. The controller 22 controls the receiving vehicle 10 via one or more of the actuators 30 to avoid the predicted vehicle maneuver of the nearby originating vehicle 10. From 514, the method 500 proceeds to 516 and ends.

It should be emphasized that many variations and modifications may be made to the herein-described embodiments, the elements of which are to be understood as being among other acceptable examples. All such modifications and variations are intended to be included herein within the scope of this disclosure and protected by the following claims. Moreover, any of the steps described herein can be performed simultaneously or in an order different from the steps as ordered herein. Moreover, as should be apparent, the features and attributes of the specific embodiments disclosed herein may be combined in different ways to form additional embodiments, all of which fall within the scope of the present disclosure.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment.

Moreover, the following terminology may have been used herein. The singular forms “a,” “an,” and “the” include plural referents unless the context clearly dictates otherwise. Thus, for example, reference to an item includes reference to one or more items. The term “ones” refers to one, two, or more, and generally applies to the selection of some or all of a quantity. The term “plurality” refers to two or more of an item. The term “about” or “approximately” means that quantities, dimensions, sizes, formulations, parameters, shapes and other characteristics need not be exact, but may be approximated and/or larger or smaller, as desired, reflecting acceptable tolerances, conversion factors, rounding off measurement error and the like and other factors known to those of skill in the art. The term “substantially” means that the recited characteristic parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

A plurality of items may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. Furthermore, where the terms “and” and “or” are used in conjunction with a list of items, they are to be interpreted broadly, in that any one or more of the listed items may be used alone or in combination with other listed items. The term “alternatively” refers to selection of one of two or more alternatives and is not intended to limit the selection to only those listed alternatives or to only one of the listed alternatives at a time, unless the context clearly indicates otherwise.

The processes, methods, or algorithms disclosed herein can be deliverable to/implemented by a processing device, controller, or computer, which can include any existing programmable electronic control unit or dedicated electronic control unit. Similarly, the processes, methods, or algorithms can be stored as data and instructions executable by a controller or computer in many forms including, but not limited to, information permanently stored on non-writable storage media such as ROM devices and information alterably stored on writeable storage media such as floppy disks, magnetic tapes, CDs, RAM devices, and other magnetic and optical media. The processes, methods, or algorithms can also be implemented in a software executable object. Alternatively, the processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components. Such example devices may be on-board as part of a vehicle computing system or be located off-board and conduct remote communication with devices on one or more vehicles.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further exemplary aspects of the present disclosure that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. A method for controlling an automotive vehicle, comprising:
providing a first actuator configured to control acceleration and braking of a first vehicle, a second actuator configured to control steering of the first vehicle, and a controller in communication with the first and second actuators, the controller configured to selectively control the first and second actuators in an autonomous mode along a first trajectory according to an automated driving system;
receiving, by the controller, eye movement data and vehicle characteristic data from a second vehicle using V2X communication;
determining, by the controller, a predicted vehicle maneuver of the second vehicle from the eye movement data and the vehicle characteristic data;
determining, by the controller, a trajectory adjustment for the first vehicle based on the predicted vehicle maneuver of the second vehicle; and
automatically controlling, by the controller, the first and second actuators to implement the trajectory adjustment.

2. The method of claim 1 further comprising analyzing, by the controller, the eye movement data and the vehicle characteristic data to temporally correlate the eye movement data and the vehicle characteristic data and generate a matched dataset.

3. The method of claim 2, wherein the eye movement data includes a gaze position and a gaze duration.

4. The method of claim 3, wherein the vehicle characteristic data includes a vehicle speed, a vehicle acceleration, and a vehicle steering wheel angle of the second vehicle.

5. The method of claim 4, wherein the matched dataset includes the gaze position, a duration of the gaze position, the vehicle speed, the vehicle acceleration, the vehicle steering wheel angle, and a vehicle position.

6. The method of claim 1 further comprising determining, by the controller, a prediction model status, wherein the prediction model status is whether a prediction model is locally stored on the controller of the first vehicle.

7. The method of claim 6 further comprising accessing, by the controller via V2X communication, a remote source hosting an updated prediction model if the prediction model is not locally stored on the controller of the first vehicle.

8. The method of claim 7 further comprising transmitting, by the controller via V2X communication, the eye movement data and the vehicle characteristic data to the remote source.

9. The method of claim 1, wherein the trajectory adjustment includes one or more of a longitudinal, lateral, and speed adjustment to the first trajectory of the first vehicle.

10. An automotive vehicle, comprising:
a wireless communication system configured to transmit and receive V2X communication;
a first actuator configured to control acceleration and braking of the automotive vehicle;
a second actuator configured to control steering of the automotive vehicle; and
a controller in communication with the first and second actuators and the wireless communication system, the controller configured to selectively control the first and second actuators in an autonomous mode along a first trajectory according to an automated driving system, the controller configured to
receive eye movement data and vehicle characteristic data from a second vehicle via the wireless communication system using V2X communication;
determine a predicted vehicle maneuver of the second vehicle from the eye movement data and the vehicle characteristic data;
determine a trajectory adjustment for the automotive vehicle based on the predicted vehicle maneuver of the second vehicle; and
automatically control the first and second actuators to implement the trajectory adjustment.

11. The automotive vehicle of claim 10, wherein the controller is further configured to analyze the eye movement data and the vehicle characteristic data to temporally correlate the eye movement data and the vehicle characteristic data and generate a matched dataset.

12. The automotive vehicle of claim 10, wherein the controller is further configured to determine a prediction model status, wherein the prediction model status is whether a prediction model is locally stored on the controller of the automotive vehicle.

13. The automotive vehicle of claim 12, wherein the controller is further configured to access, via V2X communication, a remote source hosting an updated prediction model if the prediction model is not locally stored on the controller of the automotive vehicle.

14. The automotive vehicle of claim 13, wherein the controller is further configured to transmit, via V2X communication, the eye movement data and the vehicle characteristic data to the remote source.

15. The automotive vehicle of claim 10, wherein the trajectory adjustment includes one or more of a longitudinal, lateral, and speed adjustment to the first trajectory of the automotive vehicle.

16. A system for controlling an automotive vehicle, comprising:
a wireless communication system;
a first actuator configured to control acceleration and braking of the automotive vehicle;
a second actuator configured to control steering of the automotive vehicle; and
a controller in communication with the first and second actuators, the controller configured to selectively control the first and second actuators in an autonomous mode along a first trajectory according to an automated driving system, the controller configured to
receive eye movement data and vehicle characteristic data from a second vehicle using V2X communication;
analyze the eye movement data and the vehicle characteristic data to temporally correlate the eye movement data and the vehicle characteristic data and generate a matched dataset;
determine a predicted vehicle maneuver of the second vehicle from the matched dataset;
determine a trajectory adjustment for the automotive vehicle based on the predicted vehicle maneuver of the second vehicle; and
automatically control the first and second actuators to implement the trajectory adjustment.

17. The system of claim 16, wherein the controller is further configured to determine a prediction model status, wherein the prediction model status is whether a prediction model is locally stored on the controller of the automotive vehicle.

18. The system of claim 17, wherein the controller is further configured to access, via V2X communication using the wireless communication system, a remote source hosting an updated prediction model if the prediction model is not locally stored on the controller of the automotive vehicle.

19. The system of claim 18, wherein the controller is further configured to transmit, via V2X communication using the wireless communication system, the eye movement data and the vehicle characteristic data to the remote source.

20. The system of claim 16, wherein the trajectory adjustment includes one or more of a longitudinal, lateral, and speed adjustment to the first trajectory of the automotive vehicle.
